(19) United States
(12) Patent Application Publication
(10) Pub. No.: US 2026/0177222 A1
(43) Pub. Date: Jun. 25, 2026

(54) MOTOR VEHICLE WITH A LIGHTING DEVICE, AND A CORRESPONDING LIGHTING DEVICE

(71) Applicant: AUDI AG, Ingolstadt (DE)

(72) Inventors: Berthold BÜDEL, Ingolstadt (DE); Johannes SCHEUCHENPFLUG, Baar-Ebenhausen (DE)

(21) Appl. No.: 19/416,598

(22) Filed: Dec. 11, 2025

(30) Foreign Application Priority Data
Dec. 23, 2024 (DE) 102024139591.5

(51) Int. Cl. F21S 45/47; F21S 41/30

(52) U.S. Cl. CPC F21S 45/47; F21S 41/30

(57) ABSTRACT

A motor vehicle is provided that includes a lighting device with at least one light source for generating light, wherein the at least one light source is thermally connected to at least one vehicle-side cooling component of the motor vehicle in such a way that heat from the at least one light source can be dissipated to the at least one cooling component for cooling the at least one light source.

### BACKGROUND

### Technical Field

The present disclosure relates to a motor vehicle comprising a lighting device with at least one light source for generating light.

### Description of the Related Art

The original purpose of lighting devices on motor vehicles, particularly in the darkness, is to illuminate the surroundings of the motor vehicle, on the one hand, and to make the motor vehicle more visible to other road users, on the other hand.

In modern motor vehicles, lighting systems fulfill purposes that go far beyond the aspects mentioned above. For example, lighting devices are used to generate projections in the surroundings of the motor vehicle, in particular on the ground.

For example, DE102018132392A1 discloses a lighting arrangement installed in a door sill of the motor vehicle, which comprises a light source, a light modulator, a projection lens, and a movable mirror, wherein these components are installed in a common housing.

DE202015104894U1 discloses a lighting device for a motor vehicle that is installed in a body panel, a bumper, or a vehicle door. The lighting device comprises a light source, lenses, a masking element for displaying a logo, and a reflector unit, by way of which the light generated by the light source is deflected onto a projection surface.

One problem associated with a light source in such a lighting device is that it generates heat. In this respect, care must be taken to ensure that the resulting temperature does not reach a temperature threshold above which damage to the light source or other components of the lighting device could occur. To counteract this, derating of the light source is often provided, which reduces the brightness or output of the light source and, therefore, the heat generated thereby. This, in turn, leads to a reduction in the brightness of the light generated by the lighting device, which is disadvantageous with regard to the function to be realized by the user by way of the lighting device.

### BRIEF SUMMARY

The disclosure provides an improved concept with regard to a lighting device for a motor vehicle, in particular with regard to heat generated by a light source of the lighting device.

In accordance with the disclosure, this is achieved in a motor vehicle of the type mentioned at the outset in that the at least one light source is thermally connected to at least one vehicle-side cooling component of the motor vehicle in such a way that heat from the at least one light source can be dissipated to the at least one cooling component in order to cool the at least one light source.

In the context of the present disclosure, it is advantageously realized that a cooling effect arising due to the dissipation of heat and affecting the light source is significantly increased for a period of time after the light source is switched on, up to which the aforementioned derating is required, or that the requirement for such derating is completely eliminated. The disclosure is based on the idea that this cooling effect is realized significantly, in particular completely, by the thermal connection of the light source to the cooling component. In other words, a significant proportion, in particular a majority, of the heat generated by the light source flows away toward the cooling component. Advantageously, the cooling component may be a component already provided in the motor vehicle. The cooling component may be a vehicle-mounted component. The cooling component may consist of a material and have a mass such that the heat capacity of the cooling component is sufficiently high to achieve the effect that the cooling component is capable of absorbing a sufficient amount of heat and, if necessary, dissipating it, in particular to the surroundings.

The thermal connection between the light source and the cooling component allows a sufficiently high flux of heat or heat flow from the light source to the cooling component for the stated purpose. In this case, heat transfer may advantageously be enabled via at least one direct contact. Heat transfer thus advantageously takes place, in particular exclusively, by way of a contact-based transfer between the light source and the cooling component and, if necessary, at least one further component arranged between the light source and the cooling component, which is thermally connected to the light source and the cooling component accordingly.

The cooling component and, if applicable, a component arranged between the light source and the cooling component may be made of a metal, since metals have particularly high heat transfer coefficients. To further increase the heat flow, a heat-conducting paste may be arranged between parts by way of which the thermal connection is formed.

Advantageously, the lighting device may have a housing in which the at least one light source is accommodated. The housing may be made of metal. The housing may be rectangular or box-shaped. The housing may comprise several, in particular flat, walls. The light source and any other components of the lighting device are housed inside the housing, so that these components are protected from unwanted external influences, such as dirt or moisture. Since the light source is located inside the housing, the housing may comprise at least one outlet opening or an outlet window through which the light generated by the light source escapes to the outside.

According to some embodiments, the dissipation of heat can be realized or enhanced in that the at least one light source and the cooling component and/or a component thermally connected to the cooling component, via which the dissipation of heat from the at least one light source to the at least one cooling component takes place, are arranged opposite each other on a wall of the housing. The wall forms an inner surface facing the interior of the housing and an outer surface facing the exterior of the housing, wherein the light source is in thermal contact with the inner surface and the cooling component is in thermal contact with the outer surface. The housing, or at least this wall of the housing, may be made of a metal or another material with a sufficiently high thermal conductivity.

In addition or alternatively, the dissipation of the heat can be realized or enhanced by the housing being open on at least one side, wherein the at least one component, which is in, in particular direct, contact with the cooling component and/or with the or a component thermally connected to the cooling component, via which the dissipation of heat from the at least one light source to the at least one cooling component takes place, is arranged in the region of the open side. In contrast to the previously explained embodiment, a component between the light source and the cooling component via which the heat transfer takes place, namely the wall, is avoided so that the heat transfer can take place even more effectively. With regard to the attachment of the light source, it may be provided that the light source is attached to a wall of the housing or to a supporting structure of the lighting device. In addition, the light source may be attached to the cooling component and/or to the component or a component thermally connected to the cooling component. Since the open side of the housing could fundamentally reduce the intended protective effect of the housing, it is conceivable that the open side could be closed by way of the cooling component and/or at least one other component of the motor vehicle, or that the open side is covered thereby.

It is conceivable that the dissipation of the heat is realized or reinforced in that the at least one light source and/or the lighting device is fastened by way of at least one fastener to the cooling component and/or to the component or a component thermally connected to the cooling component, via which the heat is dissipated from the at least one light source to the at least one cooling component. The fastener serves two synergistic purposes in the present case, namely, on the one hand, the mechanical fixation of the lighting device or the light source, namely via the mechanical connection to the cooling component, and, on the other hand, a realization or enlargement or reinforcement of the thermal bridge existing between the light source and the cooling component.

The at least one fastener can be at least one screw, in particular, made of metal. Thus, the housing and the cooling component, or the component thermally connected to the cooling component, may each comprise a bore which is aligned with the other and which is penetrated by the screw. At least one of these bores may have an internal thread that engages in an external thread of the screw. In addition or alternatively, the at least one fastener may take the form of a rivet, in particular, a metal rivet, and/or a welded joint or bead.

The at least one fastener may be a holding device, which in particular consists of a metal. The holding device serves as a mechanical interface between the light source and the cooling component or the component thermally connected to the cooling component. The holding device may have an appropriately shaped or bent metal sheet. The holding device may be connected to the light source, on the one hand, and to the cooling component or the component thermally connected to the cooling component, on the other hand. The holding device may support the light source, wherein the light source is fastened to the holding device by way of a fastener, such as a screw, or is gripped by a section of the holding device, in particular, in a clamp-like manner. The holding device may be attached to the cooling component or to the component thermally connected to the cooling component, wherein a fastener, such as a screw, can be provided for this purpose. In addition, a section of the holding device may clasp the cooling component or the component thermally connected to the cooling component, in particular, in a clamp-like manner.

It is also conceivable that the dissipation of heat is realized or enhanced in that the lighting device has at least one flange which is in contact, in particular direct contact, with the cooling component and/or with the component or a component thermally connected to the cooling component, via which the heat is dissipated from the at least one light source to the at least one cooling component. The flange increases the contact surface, which is further conducive to heat transfer. The flange may be or form part of the housing. It is therefore conceivable that the flange projects, in particular straight and flush, from a wall of the housing that is in contact with the cooling component or with the component thermally connected to the cooling component, so that the flange is also in contact therewith. Advantageously, the lighting device may be attached to the cooling component or to the component thermally connected to the cooling component via the flange. For example, the bore provided above in connection with the lighting device may be designed to accommodate the screw, so that it passes through the flange. The aforementioned welded and/or riveted joint may also be formed in the area of the flange.

Advantageously, the cooling effect resulting from the dissipation of the heat may be enhanced in that the cooling component and/or the component or a component thermally connected to the cooling component, via which the heat is dissipated from the at least one light source to the at least one cooling component, comprises at least one cooling element, by way of which the heat can be dissipated to a cooling fluid, which is in particular ambient air or is incorporated in an active cooling system of the motor vehicle. In some embodiments, therefore, not only is the heat absorption capability of the cooling element alone used to achieve the cooling effect, but heat is also dissipated to the cooling fluid. In this case, the cooling element may be geometrically shaped in such a way that the contact surface between the cooling element and the cooling fluid is as large as possible. In particular, the at least one cooling element may be or comprise at least one cooling fin and/or at least one cooling rib. With regard to the cooling fluid, it may be provided that this is ambient air flowing along the cooling element, in particular due to the airstream. Alternatively, the cooling fluid, which in this case may be gaseous or liquid, may be integrated into an active cooling system of the motor vehicle, for example, into a cooling circuit.

The cooling component may be a section or a component of the body of the motor vehicle. In particular, since the body realizes the majority of the mechanical strength of the motor vehicle, it also meets the requirements for the cooling component provided for in the context of the present disclosure, i.e., in particular with regard to the above-mentioned sufficient thermal capacity. For example, the body is typically made of a metal and is also sufficiently heavy to provide a sufficient cooling effect for the light source.

Advantageously, the cooling component may be a vehicle sill. Advantageously, this may be a vehicle sill or door sill extending in the longitudinal direction of the vehicle, which extends essentially in a straight line below the side door or entry areas of the motor vehicle. The vehicle sill is typically realized as an extruded profile, especially a metal one. For example, the lighting device can be arranged on or in the vehicle sill, in particular, be attached to it. A specific installation position of the lighting device may be below a vehicle pillar, for example, below an A, B or C pillar.

It is also conceivable that the cooling component may be a bumper of the motor vehicle. A bumper, which may also be referred to as a fender, for example, typically extends along the front or rear of the motor vehicle in a transverse direction and is used to absorb impacts that occur in the event of a crash. Thus, the use of a metal as a material is also provided for the bumper, so that the requirements for the cooling component provided for in the context of the present disclosure are also fulfilled here. The lighting device may be advantageously arranged on or in the bumper, in particular attached to it. It is particularly advantageous for the lighting device to be arranged centrally on or in the bumper in relation to the transverse direction of the vehicle.

Advantageously, the cooling component may be clad by way of a trim part, consisting in particular of a plastic, wherein the lighting device is arranged between the cooling component and the trim part or a section of the trim part, in particular a wall of the trim part. In other words, the trim part not only covers the cooling component but also covers the lighting device, which is advantageous in terms of aesthetic aspects, on the one hand, and in terms of additional mechanical protection of the lighting device, on the other hand. The trim part may have a recess forming an opening or a window through which the light emitted by the lighting device escapes to the outside. For this purpose, it may be advantageous if the outlet opening or the outlet window of the lighting device and the recess in the trim part are aligned with one another in relation to the direction of light propagation.

Advantageously, the lighting device may bea projection device, by way of which a projection can be generated on a projection surface in an area surrounding the motor vehicle. The projection, especially in color, may be an image, an animation or a film. The projection surface may be a wall present in the surroundings of the motor vehicle. The projection device may be a ground projection device, by way of which a projection can be generated on a ground surface in the surroundings of the motor vehicle. A corresponding ground projection device is often used in connection with the implementation of a coming-home or leaving-home scenario. It may be particularly advantageous to generate the projection on the ground in front of, behind or next to the vehicle. The horizontal distance between the vehicle and the projection or the display surface or the touchdown point of the projection may be a maximum of 0.3 m. This measure, in particular, can make the originator of the projection, i.e., the motor vehicle, understandable to other road users. The maximum distance between the vehicle and the projection may be between 0.1 m and 5.0 m, in particular between 0.5 m and 2.0 m, and in some instances may be 1.0 m.

It is conceivable that the at least one light source is arranged in a fixed position in relation to the cooling component. The fixed connection is realized in particular by the light source being attached directly to the cooling component and/or to the component or to a component thermally connected to the cooling component. In particular, compared with embodiments in which the light source is arranged movably, for example, to realize repositioning of the projection that can be generated by the lighting device, the fixed arrangement of the light source is particularly advantageous for realizing the most effective possible cooling effect by way of the cooling component. Thus, the fixed arrangement of the light source enables the most effective possible thermal connection to the cooling component in all operating situations, which cannot be cancelled by moving the light source away from this position.

In particular in the context of the aforementioned embodiment of the disclosure, it is conceivable that the at least one light source and an imaging unit form an imaging device of the lighting device which is arranged in a fixed position with respect to the cooling component, by way of which an image representation realized by way of the light, which in particular realizes the projection or a projection, can be generated. The propagation path of the light realizing the image representation can be influenced by way of an optical unit, as will be described below. The imaging unit may be a micromirror actuator. A micromirror actuator, often also referred to as a digital mirror device or DMD, is a microelectromechanical component for dynamic modulation of the light generated by the light source. Corresponding images or projections can therefore be generated using the micromirror actuator. The micromirror actuator may comprise micromirrors arranged in a matrix form with an edge length in the order of micrometers. The position of the micromirrors can be adjusted individually, in particular by way of the force of electrostatic fields. The imaging unit may additionally be a TFT element, an LCOS element or a MEMS mirror.

It is conceivable that a change in the direction of emission of the light generated by the lighting device is desired, in particular, to change the position of the projection. In particular to enable this, it may be provided according to the disclosure that an emission direction of the light generated by way of the at least one light source can be influenced by way of at least one optical unit which can be adjusted in position and/or pivoted with respect to the cooling component and by way of which a propagation path of the light can be influenced. Within the context of this embodiment, therefore, only components of the lighting device that do not require cooling and for which this design is unproblematic in this respect are provided in such a way that their position can be changed or pivoted. Thus, specifically within the context of this embodiment, it is provided that the light source or the imaging device is arranged in a fixed position, so that the direction in which the light is emitted from the light source is always the same. The direction of propagation of the light is now influenced by the optical unit, which is connected to a controllable, in particular electromechanical, actuator for this purpose. A control device of the lighting device or of the motor vehicle may be provided to generate corresponding control signals.

Changing the direction in which the light generated by the lighting device is emitted is particularly desirable when the motor vehicle comprises air springs that can be used to adjust the height of the motor vehicle. This allows the motor vehicle to be raised when, for example, a journey through rough terrain is imminent. A change in the distance of the projection from the motor vehicle due to the change in the height of the motor vehicle can be avoided or compensated for by changing the direction of emission.

Alternatively, an embodiment is also conceivable in which no electromechanical components are provided. In this case, it is conceivable that the direction of emission of the light generated by the at least one light source is specified by way of at least one optical unit that cannot be changed in position or pivoted with respect to the cooling component.

It is conceivable that the at least one optical unit comprises a reflector. The reflector may be a mirror or a prism that can be adjusted by way of an actuator, for example, an electromechanical actuator, in particular with regard to the position or pivot angle. It is also conceivable that the reflector is a free-form reflector or a diffractive optical element (DOE).

It should also be noted that the lighting device, in particular the imaging device and/or the optical unit, comprises at least one beam-shaping element, for example an optical lens, by way of which beam expansion or beam focusing of the light beams generated by the light source can be realized.

The present disclosure further relates to a lighting device for a motor vehicle, comprising at least one light source for generating light. According to the disclosure, the lighting device includes at least one light source that is thermally connected or connectable to a cooling component of the motor vehicle in such a way that heat from the at least one light source can be dissipated to the cooling component in order to cool the at least one light source. All the advantages, features and aspects explained in connection with the motor vehicle according to the disclosure are equally transferable to the lighting device according to the disclosure and vice versa.

### BRIEF DESCRIPTION OF THE SEVERAL VIEWS OF THE DRAWINGS

Further advantages, features, aspects and details of the present disclosure can be seen from the exemplary embodiments explained below and from the figures.

FIG. 1 is a schematic top view of a motor vehicle according to the disclosure, according to one exemplary embodiment, comprising multiple lighting devices according to the disclosure, according to respective exemplary embodiments.

FIG. 2 is a schematic sectional view of a section of the motor vehicle according to the disclosure of FIG. 1, comprising one of the lighting devices according to the disclosure, which is realized according to a first exemplary embodiment.

FIG. 3 is a schematic, perspective view of another of the lighting devices according to the disclosure of the motor vehicle of FIG. 1, which is realized according to a second exemplary embodiment.

FIG. 4 is a schematic sectional view of a section of the motor vehicle according to the disclosure of FIG. 1, comprising one of the lighting devices according to the disclosure, which is realized according to a third exemplary embodiment.

### DETAILED DESCRIPTION

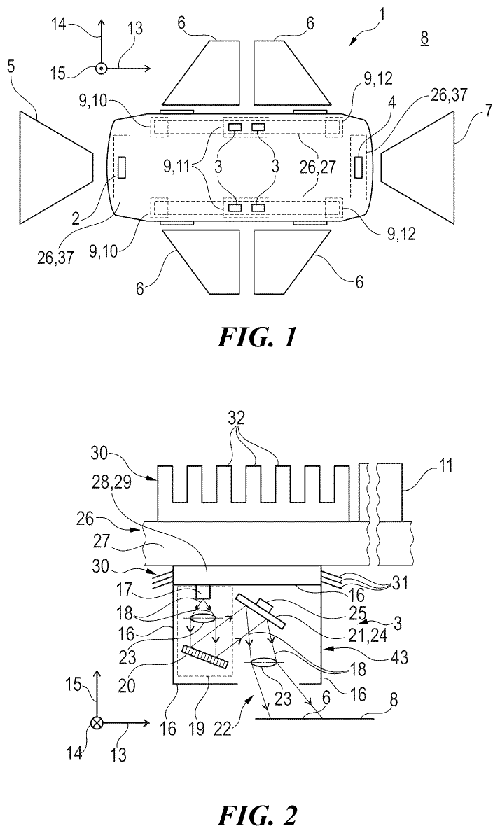

FIG. 1 shows a top view of a motor vehicle 1 according to the disclosure, in accordance with an exemplary embodiment, comprising a plurality of lighting devices 2, 3, 4 according to respective exemplary embodiments. A total of six lighting devices 2, 3, 4 are provided, namely a front lighting device 2, four side lighting devices 3 and a rear lighting device 4.

Each of the lighting devices 2, 3, 4 is a projection device by way of which a respective projection 5, 6, 7 can be generated in the surroundings 8 of the motor vehicle 1. Specifically, the projection device is a ground projection device, so that the projections 5, 6, 7 can be generated on the ground in the surroundings 8. Thus, the front lighting device 2, which is arranged centrally in relation to the transverse direction of the vehicle, can be used to generate the projection 5 in the center of the ground in front of the motor vehicle 1. By way of the rear lighting device 4, which is arranged centrally in relation to the transverse direction of the vehicle, the projection 7 can be generated correspondingly centrally on the ground behind the motor vehicle 1. However, an off-center arrangement is conceivable, for example, if another component, such as a trailer coupling, is already provided at the central position. In this case, the projection can still be generated centrally, preferably while compensating for a distortion of the respective projection 5, 7 resulting from the geometric conditions. Each of the projections 7 extends, for example, within an area on the ground that extends between 0.3 m and 1.0 m away from the motor vehicle 1.

Of the four lighting devices 3 arranged on the side of the motor vehicle 1, two are located on the left side and two on the right side of the motor vehicle 1. Several vehicle pillars 9 are provided along the sides of the motor vehicle, namely one A-pillar 10, one B-pillar 11 and one C-pillar 12 on each of the two sides. The two side lighting devices 3 are both arranged in the area below the B-pillar 11. The projections 6 that can be generated by way of the side lighting devices 3 are arranged next to each other along the longitudinal direction of the vehicle. Alternatively, it is conceivable that instead of the two lighting devices 3 arranged below the B-pillar 11, only one lighting device is provided, which is either located below the A-pillar 10 and generates a corresponding projection to the rear, or which is located below the C-pillar 12 and generates a corresponding projection to the front. A variant is also conceivable in which a lighting device is located below the A-pillar 10 and below the C-pillar 12, and possibly below the B-pillar 11. The specific arrangement described with regard to the vehicle pillars 9 is to be understood as merely an example. A staggered arrangement is also conceivable in this respect, for example, if mounting points for a jack are provided in the area of the vehicle pillars 9.

In the following, relevant spatial directions in relation to the motor vehicle 1 are introduced, wherein corresponding coordinate systems are shown in the figures. For example, a vehicle longitudinal direction 13 extends backwards along a vehicle longitudinal axis, a vehicle transverse direction 14 extends to the right along a vehicle transverse axis, and a vehicle vertical direction 15 extends upwards along a vehicle vertical axis.

Reference is made below to FIG. 2, which shows an extremely schematic sectional view through the area of the motor vehicle 1 in which one of the two side lighting devices 3 is arranged. First of all, details relating to the lighting device 3 are explained, all of which are equally applicable in principle to the other lighting devices 2, 4.

Thus, the lighting device 3 has a housing 43 in which the components of the lighting device 3 are arranged and which has several walls 16. A light source 17 comprising several light-emitting diodes is provided within the housing 43, by way of which light 18 of different colors can be generated, which ultimately generates the respective projection 6. Furthermore, the lighting device 3 comprises a micromirror actuator 20 or DMD, which comprises micromirrors arranged in a matrix form with an edge length in the order of micrometers, wherein the micromirrors can be individually adjusted with respect to their position by way of the force action of electrostatic fields. The micromirror actuator 20 is used to generate a colored image representation that realizes the projection 6. The light source 17 and the micromirror actuator 20, which realizes an imaging unit, form an imaging device 19 of the lighting device 3, which is arranged in a fixed position in the housing 43 and by way of which the image representation or projection 6 realized by way of the light 18 is realized. Alternatively, the imaging unit may be a TFT element, an LCOS element or a MEMS mirror.

Furthermore, the lighting device 3 comprises a reflector 21, which in the present case is a mirror, by way of which the light 18 generated by the light source 17 or by the imaging device 19 can be reflected towards an exit opening 22 of the housing 43 forming an exit window. The reflector 21 may also be a prism, a free-form reflector or a DOE. Finally, the lighting device 3 comprises beam-shaping elements 23, namely optical lenses, by way of which beam expansion or beam focusing of the light beams generated by the light source 17 or light 18 can be realized.

Since the projection 6 is to be variable in position on the ground 8, the lighting device 3 comprises a position-adjustable and/or pivotable optical unit 24, by way of which the propagation path of the light 18 can be influenced and which is formed by the reflector 21. To set the respective position or pivot angle of the optical unit 24, it is connected to an electromechanical actuator 25, which can be actuated by way of the control signals of a control device of the motor vehicle 1, which is not shown in detail, to set the desired position or pivot angle of the respective optical unit 24. Alternatively, the optical unit 24 may be arranged in a fixed position in the housing 43.

Referring again to FIG. 2, aspects relating to the mechanical connection of the lighting device 3 are explained below. In the context of the present disclosure, this mechanical connection takes place in such a way that a thermal connection is provided between the light source 17 and a cooling component 26 of the motor vehicle 1 in such a way that cooling of the light source is realized due to the dissipation of heat from the light source 17 to the cooling component 26. The light source 17 is arranged in a fixed position relative to the cooling component 26.

In the present case, the cooling component 26 is a section of the body of the motor vehicle 1, namely a door sill or vehicle sill 27, which extends along the longitudinal direction 13. The aforementioned heat transfer from the light source 17 to the vehicle sill 27 is realized in that the light source 17 and a component attached to the cooling component 26, namely a holding device 28, are arranged opposite each other on one of the walls 16. Since housing 43 is made of a metal, heat is thus effectively transferred from the light source 17 to the holding device 28 and, since the holding device 28 is also made of a metal, to the cooling component 26. Thus, a further aspect of this exemplary embodiment relates to the fact that the dissipation of the heat from the light source 17 to the cooling component 26 is realized and reinforced in that the lighting device 3 and thus the light source 17 is attached to the cooling component 26 by way of a fastener 29, which is thermally connected to the cooling component accordingly and is formed by the holding device 28. The holding device 28, which is indicated only symbolically in FIG. 2, is a bent metal sheet which is connected on the one hand to the lighting device 3 and, on the other hand, to the cooling component 26. As an example, housing 43 of the lighting device 3 is gripped in a clamp-like manner by a section of the holding device 28. The holding device is attached to the cooling component 26 by way of a screw not shown in detail in FIG. 2.

A further aspect of the exemplary embodiment shown in FIG. 2 relates to an enhancement of the cooling effect produced with respect to the light source 17 in that both the cooling component 26 and a component thermally connected to the cooling component 26, namely the holding device 28, comprise a cooling element 30 that has cooling fins 31 or cooling ribs 32. The cooling element 30 of the cooling component 26 is a separate component, which is arranged on a side of the cooling component 26 facing away from the lighting device 3. Instead, the cooling element 30 of the holding device 28 is arranged on the side of it. By way of the cooling element 30, heat originating from the light source 17 is transferred to a cooling fluid, which is ambient air flowing along the respective cooling fins 31 or cooling ribs 32 due to the airstream. Alternatively, the cooling fluid may be integrated into an active cooling system of the motor vehicle 1, such as a cooling circuit.

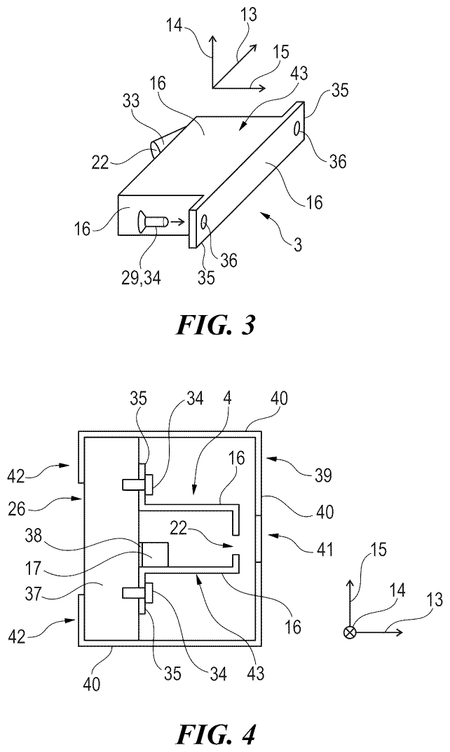

A second exemplary embodiment of the lighting device 3 is explained below with reference to FIG. 3. In principle, the aspects explained with reference to FIG. 2 apply equally to the exemplary embodiment shown in FIG. 3. Thus, the lighting device 3 according to FIG. 3 also comprises a housing 43, the outlet opening 22 of which, however, is arranged on a tubular housing section 33 projecting obliquely from the walls 16, which enables a significantly more oblique emission direction of the light 18 compared to the exemplary embodiment explained with reference to FIG. 2, so that this lighting device 3 can be arranged in particular below the C-pillar 12.

The lighting device 3, explained with reference to FIG. 3, can also be fastened to the cooling component 26, not shown in FIG. 3, by way of several fastener 29, wherein the fastener 29 are screws 34. Furthermore, it is provided that the heat dissipation from the light source 17 to the cooling component 26 is increased by the lighting device 3, specifically the housing 43 in the present case, having lateral flanges 35 which are in contact with the cooling component 26. The flanges 35 each form a flat continuation of the wall 16 shown on the right in FIG. 3, which is in contact with the cooling component 26, on the one hand, and with the light source 17, not shown in FIG. 3, on the other hand. Furthermore, the flanges 35 each have a bore 36, which is aligned with the bores of the cooling component 26, not shown in FIG. 3, and which are penetrated by one of the screws 34. The bores in the cooling component 26 each have an internal thread into which an external thread of the respective screw 34 engages.

FIG. 4 shows a schematic sectional view of a section of the motor vehicle of FIG. 1 comprising one of the lighting devices 4, which is realized according to a third exemplary embodiment, wherein this is the rear lighting device 4. Apart from the differences described below, the features explained in connection with FIG. 2 and FIG. 3 basically apply equally to the exemplary embodiment shown in FIG. 4.

Thus, the cooling component 26, to which the lighting device 4 is fastened by way of screws 34 in a manner comparable to the exemplary embodiment of FIG. 3, is a bumper 37 of the motor vehicle 1, which is made of a metal and may also be referred to as a fender. The aspects explained here for the rear lighting device 4 therefore apply equally to the front lighting device 2, wherein FIG. 4 applies to the latter in a variant that is mirrored about a vertical axis or rotated by 180°.

With regard to the housing 43 of the variant explained with reference to FIG. 4, it is provided that this is open with respect to the side facing the cooling component 26. With regard to the components arranged inside the housing 43, only the light source 17 is shown for the sake of clarity. This is attached to one of the walls 16 of the housing by fastener, not shown in detail, and is located in the area of the open side of the housing 43 in such a way that it is in contact with the cooling component 26. Although direct contact is conceivable in this respect, a layer 38 consisting of a heat-conducting paste is arranged between the cooling component 26 and the light source 17 in the present exemplary embodiment.

In the following, with renewed reference to FIG. 4, a further aspect of this exemplary embodiment is explained, which, however, may also be expressly provided in the variants explained with reference to FIG. 2 and FIG. 3 with regard to the vehicle sill 27. Thus, the cooling component 26 or the bumper 37 is clad by way of a distributed trim part 39 consisting of a plastic, wherein the lighting device 4 is arranged between the cooling component 26 and the trim part 39 or a wall 40 of the trim part 39. Consequently, the trim part 39 not only covers the cooling component 26, but also the lighting device 4. The trim part 39 comprises a recess 41 forming an opening or window, which is aligned with the outlet opening 22 of the housing 43, so that the light emitted by the lighting device 4 exits through the recess 41 to the outside. Opposite recess 41, the trim part 39 comprises a fastening section 42, which grips the cooling component 26 like a clamp for mounting purposes.

German patent application no. 102024139591.5 filed Dec. 23, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A motor vehicle, comprising:
a lighting device with at least one light source for generating light, wherein the at least one light source is thermally connected to at least one vehicle-side cooling component of the motor vehicle in such a way that heat from the at least one light source is dissipated during operation to the at least one cooling component in order to cool the at least one light source.

2. The motor vehicle according to claim 1, wherein the lighting device has a housing in which the at least one light source is accommodated, wherein the dissipation of heat is realized or enhanced, in that the at least one light source and the cooling component and/or a component thermally connected to the cooling component, via which the heat from the at least one light source is dissipated to the at least one cooling component, are arranged opposite one another on a wall of the housing, and/or
wherein the housing is open on at least one side, wherein the at least one light source, which is in contact with the cooling component and/or with the component or components thermally connected to the cooling component, via which the heat from the at least one light source is dissipated to the at least one cooling component, is arranged in the region of the open side.

3. The motor vehicle according to claim 1, wherein the dissipation of the heat is thereby realized or enhanced, in that the at least one light source and/or the lighting device is fastened by at least one fastener to the cooling component and/or a component thermally connected to the cooling component, via which the heat from the at least one light source is dissipated to the at least one cooling component.

4. The motor vehicle according to claim 3, wherein the at least one fastener is at least one screw or a holding device.

5. The motor vehicle according to claim 1, wherein the dissipation of the heat is realized or enhanced in that the lighting device, in particular a housing of the lighting device, has at least one flange which is in contact, in particular direct contact, with the cooling component and/or with the cooling component or a component which is thermally connected to the cooling component and via which the heat from the at least one light source is dissipated to the at least one cooling component.

6. The motor vehicle according to claim 1, wherein a cooling effect resulting from the dissipation of heat is enhanced in that the cooling component and/or a component thermally connected to the cooling component, via which the heat from the at least one light source is dissipated to the at least one cooling component, comprises at least one cooling element, comprising in particular at least one cooling fin and/or cooling rib, by which the heat is dissipated to a cooling fluid, which is in particular an ambient air or is incorporated in an active cooling system of the motor vehicle.

7. The motor vehicle according to claim 1, wherein the cooling component is a section or a component of the body of the motor vehicle.

8. The motor vehicle according to claim 7, wherein the cooling component is a vehicle sill, wherein the lighting device is arranged in particular below a vehicle pillar.

9. The motor vehicle according claim 1, wherein the cooling component is a bumper of the motor vehicle.

10. The motor vehicle according to claim 1 wherein the cooling component is clad by a trim part, consisting of a plastic, wherein the lighting device is arranged between the cooling component and the trim part or a section of the trim part.

11. The motor vehicle according to claim 1, wherein the lighting device is a projection device by which a projection is generated during operation on a projection surface in surroundings of the motor vehicle.

12. The motor vehicle according to claim 11, wherein the projection device is a ground projection device by which the projection is generated during operation on a ground in the surroundings of the motor vehicle in front of, behind or beside the motor vehicle.

13. The motor vehicle according to claim 1, wherein the at least one light source is arranged in a fixed position with respect to the cooling component, wherein an emission direction of the light generated by the at least one light source is influenceable by at least one optical unit which is changeable in position and/or pivotable with respect to the cooling component to influence a propagation path of the light.

14. The motor vehicle according to claim 13, wherein the at least one optical unit comprises a reflector in the form of a mirror or prism adjustable by an actuator or a free-form reflector.

15. A lighting device for a motor vehicle, comprising:
at least one light source for generating light, wherein the at least one light source is thermally connected or connectable to a vehicle-side cooling component of the motor vehicle in such a way that heat from the at least one light source is dissipated during operation to the cooling component in order to cool the at least one light source.
